(19) United States
(12) Patent Application Publication
(10) Pub. No.: US 2026/0304292 A1
(43) Pub. Date: Oct. 1, 2026

(54) BACKOFF HANDLING FOR SIB1 REQUESTS

(71) Applicant: Samsung Electronics Co., Ltd., Suwon-si (KR)

(72) Inventors: Anil Agiwal, McKinney, TX (US); Kyeongin Jeong, Frisco, TX (US)

(21) Appl. No.: 19/467,702

(22) Filed: Feb. 2, 2026

Related U.S. Application Data
(60) Provisional application No. 63/764,080, filed on Feb. 27, 2025.
(60) Provisional application No. 63/774,535, filed on Mar. 19, 2025.
(60) Provisional application No. 63/801,593, filed on May 7, 2025.

(51) Int. Cl. H04W 48/06; H04W 74/00; H04W 74/0833; H04W 84/04

(52) U.S. Cl. CPC H04W 48/06; H04W 74/006; H04W 74/0833; H04W 84/042

(57) ABSTRACT

A method of operating a user equipment (UE) includes initiating a random access (RA) procedure, and during the RA procedure, receiving a random access response (RAR) containing a medium access control (MAC) sub protocol data unit (subPDU) with a backoff indicator (BI) field. The method also includes determining whether the RA procedure was initiated for a system information block 1 (SIB1) request for a first cell, and in response to a determination that the RA procedure was initiated for the SIB1 request, setting a preamble backoff (PREAMBLE_BACKOFF) to zero milliseconds.

### CROSS-REFERENCE TO RELATED APPLICATION(S) AND CLAIM OF PRIORITY

This application claims priority under 35 U.S.C. § 119(e) to U.S. Provisional Patent Application No. 63/764,080 filed on Feb. 27, 2025, U.S. Provisional Patent Application No. 63/774,535 filed on Mar. 19, 2025, and U.S. Provisional Patent Application No. 63/801,593 filed on May 7, 2025. The above-identified provisional patent applications are hereby incorporated by reference in their entirety.

### TECHNICAL FIELD

This disclosure relates generally to wireless networks. More specifically, this disclosure relates to backoff handling for system information block 1 (SIB1) requests.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides methods and apparatuses for backoff handling for SIB1 requests.

In one embodiment, a method of operating a user equipment (UE) is provided. The method includes initiating a random access (RA) procedure, and during the RA procedure, receiving a random access response (RAR) containing a medium access control (MAC) sub protocol data unit (subPDU) with a backoff indicator (BI) field. The method also includes determining whether the RA procedure was initiated for a system information block 1 (SIB1) request for a first cell, and in response to a determination that the RA procedure was initiated for the SIB1 request, setting a preamble backoff (PREAMBLE_BACKOFF) to zero milliseconds.

In another embodiment, an electronic device is provided. The electronic device includes at least on processor including processing circuitry, and memory storing instructions. The instructions, when executed by the at least one processor individually or collectively, cause the electronic device to initiate an RA procedure, and during the RA procedure, receive a RAR containing a MAC subPDU with a BI field. The instructions, when executed by the at least one processor individually or collectively, also cause the electronic device to determine whether the RA procedure was initiated for a SIB1 request for a first cell, and in response to a determination that the RA procedure was initiated for the SIB1 request, set a PREAMBLE_BACKOFF to zero milliseconds.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for backoff handling during a random access procedure according to embodiments of the present disclosure;

FIG. 5 illustrates another example procedure for backoff handling during a random access procedure according to embodiments of the present disclosure;

FIG. 6 illustrates another example procedure for backoff handling during a random access procedure according to embodiments of the present disclosure;

FIGS. 7A-7B illustrate an example procedure for on demand SIB request according to embodiments of the present disclosure; and

FIG. 8 illustrates an example method for backoff handling for a SIB1 request according to embodiments of the present disclosure.

### DETAILED DESCRIPTION

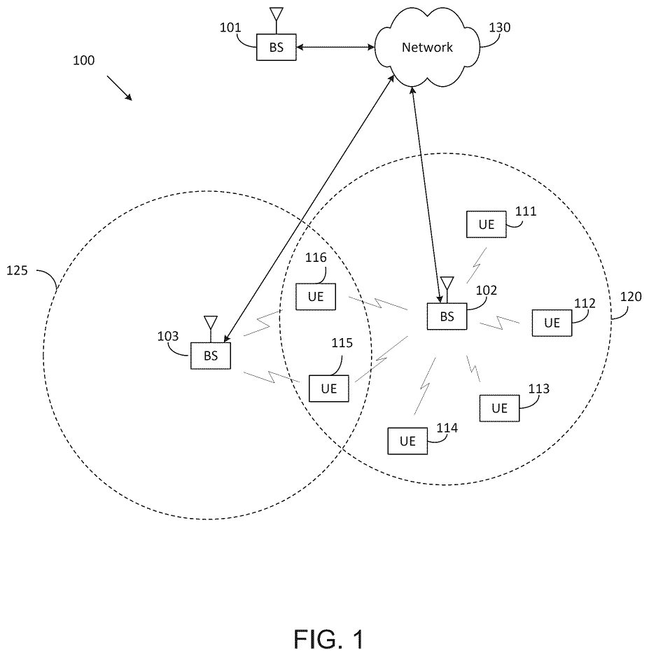

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for backoff handling for SIB1 requests. In certain embodiments, one or more of the gNBs 101-103 includes circuitry, programing, or a combination thereof, to support backoff handling for SIB1 requests in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

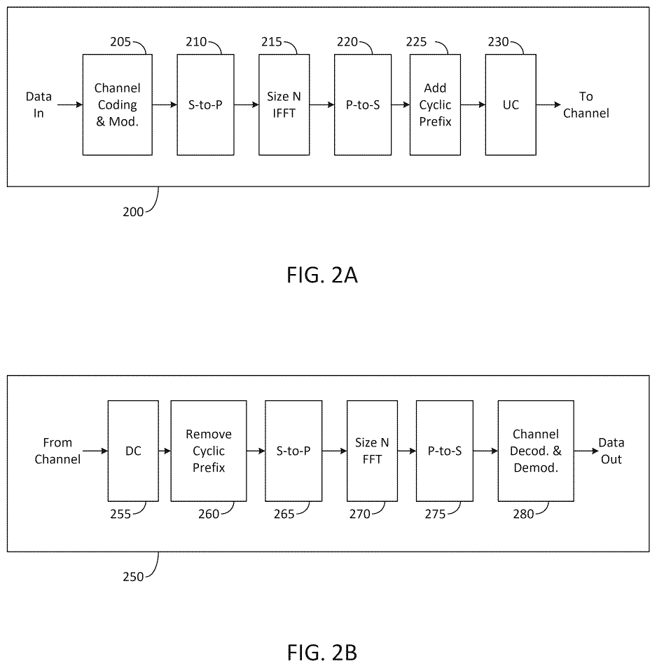

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support backoff handling for SIB1 requests as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

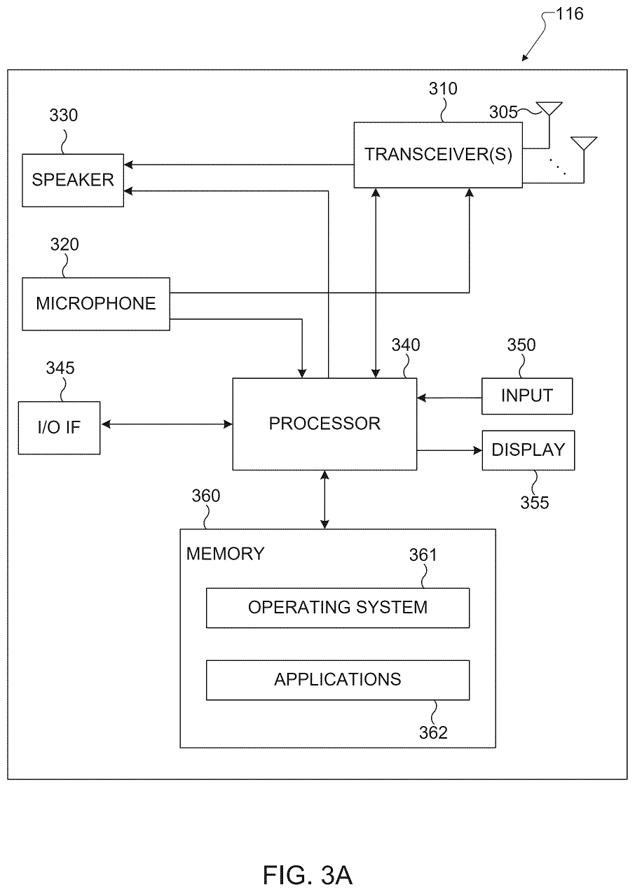

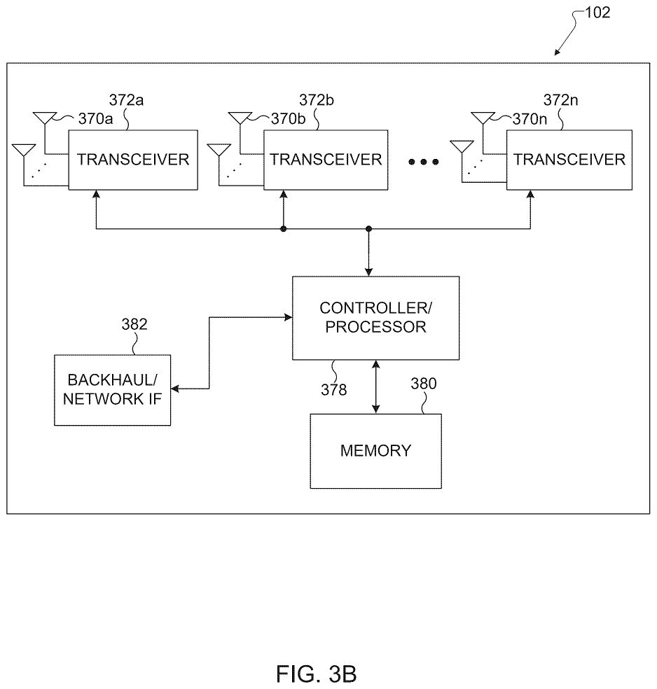

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for backoff handling for SIB1 requests as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support backoff handling for SIB1 requests as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G, 6G) supports not only lower frequency bands but also higher frequency (mmWave) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large scale antenna techniques are being considered in the design of the next generation wireless communication system. In addition, the next generation wireless communication system is expected to address different use cases having quite different requirements in terms of data rate, latency, reliability, mobility etc. However, it is expected that the design of the air-interface of the next generation wireless communication system would be flexible enough to serve UEs having quite different capabilities depending on the use case and market segment the UE caters service to the end customer. A few example use cases the next generation wireless communication system wireless system is expected to address is enhanced Mobile Broadband (eMBB), massive Machine Type Communication (m-MTC), ultra-reliable low latency communication (URLL), etc. eMBB requirements like tens of Gbps data rate, low latency, high mobility, etc. address the market segment representing conventional wireless broadband subscribers needing internet connectivity everywhere, all the time and on the go. m-MTC requirements like very high connection density, infrequent data transmission, very long battery life, low mobility, etc. address the market segment representing Internet of Things (IoT)/Internet of Everything (IoE) envisioning connectivity of billions of devices. URLL requirements like very low latency, very high reliability and variable mobility, address the market segment representing industrial automation applications, and vehicle-to-vehicle/vehicle-to-infrastructure communication, which is foreseen as one of the enablers for autonomous cars.

In the next generation wireless communication system (e.g., 5G, beyond 5G, 6G) operating in higher frequency (mmWave) bands, UEs and gNBs communicate with each other using beamforming. Beamforming techniques are used to mitigate propagation path losses and to increase the propagation distance for communication at higher frequency bands. Beamforming enhances transmission and reception performance using a high-gain antenna. Beamforming can be classified into transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a TX beam. Wireless communication systems operating at high frequency use a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of RX beam patterns of different directions. Each of these receive patterns can also be referred to as an RX beam.

The next generation wireless communication system (e.g., 5G, beyond 5G, 6G) supports standalone modes of operation as well as dual connectivity (DC). In DC a multiple Rx/Tx UE may be configured to utilize resources provided by two different nodes (or NBs) connected via non-ideal backhaul. One node acts as the Master Node (MN) and the other nodes acts as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) (SpCell[s]) and all secondary cells (SCells). In NR the term Master Cell Group (MCG) refers to a group of serving cells associated with the Master Node, comprising the primary cell (PCell) and optionally one or more (SCells. In NR the term Secondary Cell Group (SCG) refers to a group of serving cells associated with the Secondary Node, comprising the primary SCG cell (PSCell) and optionally one or more SCells. In NR, PCell refers to a serving cell in a MCG, operating on the primary frequency, in which the UE either performs the initial connection establishment procedure or initiates the connection re-establishment procedure. In NR, for a UE configured with CA, an SCell is a cell providing additional radio resources on top of the SpCell. PSCell refers to a serving cell in a SCG in which the UE performs random access when performing the Reconfiguration with Sync procedure. For Dual Connectivity operation the term SpCell refers to the PCell of the MCG or the PSCell of the SCG. Otherwise, the term SpCell refers to the PCell.

In the next generation wireless communication system (e.g., 5G, beyond 5G, 6G), a next generation node B (gNB) or base station in cell broadcast Synchronization Signal and physical broadcast channel (PBCH) block (SSB) comprises primary and secondary synchronization signals (PSS, SSS) and system information (SI). SI includes common parameters needed to communicate in cell. In the fifth generation wireless communication system (also referred to as next generation radio or NR), SI is divided into the master information block (MIB) and a number of s (SIBs) where: the MIB is always transmitted on the broadcast channel (BCH) with a periodicity of 80 ms and repetitions made within 80 ms and the MIB includes parameters that are used to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI messages, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and positioning SIBs (posSIBs) are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window, and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in the SIB1. A cell specific SIB is applicable only within a cell that provides the SIB while an area specific SIB is applicable within an area referred to as an SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using an RRCReconfiguration message (e.g., if the UE has an active BWP with no common search space configured to monitor system information), paging, or upon request from the UE. In an RRC_CONNECTED state, the UE acquires the required SIB(s) only from the PCell. For PSCell and SCells, the network provides the required SI by dedicated signaling (i.e., within an RRCReconfiguration message). Nevertheless, the UE shall acquire the MIB of the PSCell to get system frame number (SFN) timing of the SCG (which may be different from MCG). Upon a change of relevant SI for the SCell, the network releases and adds the concerned SCell. For the PSCell, the required SI can only be changed with Reconfiguration with Sync.

In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state or for a SIB1 request or for an SI request. Several types of random-access procedure are supported such as contention based random access, contention free random access and each of these can be one of 2 step or 4 step random access.

In the next generation wireless communication system (e.g., 5G, beyond 5G, 6G), A physical downlink control channel (PDCCH) is used to schedule DL transmissions on a physical downlink shared channel (PDSCH) and UL transmissions on a physical uplink shared channel (PUSCH), where Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the physical resource block(s) (PRB[s]) and OFDM symbol(s) where the UE may assume no transmission is intended for the UE; transmission of transmit power control (TPC) commands for the physical uplink control channel (PUCCH) and PUSCH; transmission of one or more TPC commands for sounding reference signal (SRS) transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mappings are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. Each search space identifier is unique amongst the BWPs of a serving cell. An identifier of a search space configuration to be used for a specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0.$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with it. A list of CORESET configurations is signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots depends on radio frame for each supported SCS is pre-defined in NR. Each CORESET configuration is associated with a list of Transmission configuration indicator (TCI) states. One DL reference signal (RS) identification (ID) (SSB or channel state information [CSI] RS) is configured per TCI state. The list of TCI states corresponding to a CORESET configuration is signaled by the gNB via radio resource control (RRC) signaling. One of the TCI states in a TCI state list is activated and indicated to the UE by the gNB. The TCI state indicates the DL TX beam (the DL TX beam is quasi co-located [QCLed] with the SSB/CSI RS of the TCI state) used by the gNB for transmission of the PDCCH in the PDCCH monitoring occasions of a search space.

In the next generation wireless communication system (e.g., 5G, beyond 5G, 6G), bandwidth adaptation (BA) is supported. With BA, the receive and transmit bandwidth of a UE need not be as large as the bandwidth of the cell and can be adjusted: the width can be ordered to change (e.g., to shrink during a period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is always one active UL and DL BWP at any point in time. BWP switching for a Serving Cell is used to activate an inactive BWP and deactivate an active BWP at a particular moment in time. BWP switching is controlled by the PDCCH indicating a downlink assignment or an uplink grant, by the bwp-InactivityTimer, by RRC signaling, or by the medium access control (MAC) entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both the UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), access to cell is not allowed if the cell is not suitable due to one or more of the following reasons:
this cell belongs to a public land mobile network (PLMN) which is not indicated as being equivalent to the registered PLMN, or
this cell is a closed access group (CAG) cell that belongs to a PLMN which is equivalent to the registered PLMN but with no CAG identification (CAG-ID) that is present in the UE's allowed CAG list being broadcasted, or
this cell is not a CAG cell and the CAG-only indication in the UE is set, or
this cell does not belong to a standalone non-public network (SNPN) that is equal to the registered or selected SNPN of the UE in SNPN access mode,

Access to a cell is not allowed if the cell is considered as barred based on following: Cell status and cell reservations are indicated in the MIB or SIB1 message by means of following fields:
cellBarred (IE type: “barred” or “not barred”) Indicated in a MIB message. In case of multiple PLMNs or NPNs indicated in SIB1, this field is common for all PLMNs and NPNs. This field is ignored by UEs supporting a non-terrestrial network (NTN) while cellBarredNTN is included in SIB1.
cellBarredNTN (IE type: “barred” or “not barred”) Indicated in a SIB1 message. In case of multiple PLMNs indicated in SIB1, this field is common for all PLMNs. This field is ignored if the UE does not support NTN connectivity.
cellBarredRedCap1Rx (IE type: “barred” or “not barred”) Indicated in a SIB1 message. In case of multiple PLMNs or NPNs indicated in SIB1, this field is common for all PLMNs and NPNs. This field is only applicable to reduced capability (RedCap) UEs.
cellBarredRedCap2Rx (IE type: “barred” or “not barred”) Indicated in a SIB1 message. In case of multiple PLMNs or non-public networks (NPNs) indicated in SIB1, this field is common for all PLMNs and NPNs. This field is only applicable to RedCap UEs.
cellReservedForOperatorUse (IE type: “reserved” or “not reserved”) Indicated in a SIB1 message. In case of multiple PLMNs or NPNs indicated in SIB1, this field is specified per PLMN or per SNPN.
cellReservedForOtherUse (IE type: “true”) Indicated in a SIB1 message. In case of multiple PLMNs indicated in SIB1, this field is common for all PLMNs.
cellReservedForFutureUse (IE type: “true”) Indicated in a SIB1 message. In case of multiple PLMNs or NPNs indicated in SIB1, this field is common for all PLMNs and NPNs.
halfDuplexRedCapAllowed (IE type: “true”) Indicated in a SIB1 message. In case of multiple PLMNs or NPNs indicated in SIB1, this field is common for all PLMNs and NPNs. This field is only applicable to RedCap UEs.
iab-Support (IE type: “true”) Indicated in a SIB1 message. In case of multiple PLMNs or NPNs indicated in SIB1, this field is specified per PLMN or per SNPN.

When a cell status is indicated as “not barred” and “not reserved” for operator use and not “true” for other use and not “true” for future use,
UEs shall treat this cell as candidate during the cell selection and cell reselection procedures.

When a cell broadcasts any CAG-IDs or network identifiers (NIDs) and the cell status is indicated as “not barred” and “not reserved” for operator use and “true” for other use, and not “true” for future use:
All NPN-capable UEs shall treat this cell as candidate during the cell selection and cell reselection procedures, other UEs shall treat this cell as if cell status is “barred”.

When a cell status is indicated as “true” for other use, and either a cell does not broadcast any CAG-IDs or NIDs or does not broadcast any CAG-IDs and the UE is not operating in SNPN Access Mode,
The UE shall treat this cell as if cell status is “barred”.

When a cell status is indicated as “true” for future use,
The UE shall treat this cell as if cell status is “barred”.

When cellBarredNTN is not broadcast in a cell,
For NTN access, the UE shall treat this cell as if cell status is “barred”.

When halfDuplexRedCapAllowed is not broadcast in a cell,
A RedCap UE only capable of operating in half-duplex for FDD shall treat this cell as if cell status is “barred”.

When a cell status is indicated as “not barred” and “reserved” for operator use for any PLMN/SNPN and not “true” for other use and not “true” for future use,
UEs assigned to Access Identity 11 or 15 operating in their home PLMN (HPLMN)/equivalent HPLMN (EHPLMN) shall treat this cell as a candidate during the cell selection and reselection procedures if the field cellReservedForOperatorUse for that PLMN set to “reserved”.
UEs assigned to Access Identity 11 or 15 shall treat this cell as a candidate during the cell selection and reselection procedures if the field cellReservedForOperatorUse for selected/registered SNPN is set to “reserved”.
UEs assigned to an Access Identity 0, 1, 2 and 12 to 14 shall behave as if the cell status is “barred” in case the cell is “reserved for operator use” for the registered PLMN/SNPN or the selected PLMN/SNPN.
UEs assigned to Access Identity 3 shall behave as if the cell status is “barred” in case the cell is “reserved for operator use” for the registered PLMN or the selected PLMN.

When a cell status “barred” is indicated or to be treated as if the cell status is “barred”:
The UE is not permitted to select/reselect this cell, not even for emergency calls.
The UE shall select another cell according to the following rule:
   If the cell is to be treated as if the cell status is “barred” due to being unable to acquire the MIB:
   the UE may exclude the barred cell as a candidate for cell selection/reselection for up to 300 seconds.
   the UE may select another cell on the same frequency if the selection criteria are fulfilled.
Otherwise:
   If the UE is a RedCap UE, the UE shall acquire SIB1 and, in the remainder of this procedure, consider ‘intraFreqReselection in the MIB’ to be ‘intraFreqReselectionRedCap in SIB1’, if available.
If the cell is to be treated as if the cell status is “barred” due to being unable to acquire the SIB1:
   the UE may exclude the barred cell as a candidate for cell selection/reselection for up to 300 seconds.
   the UE may select another cell on the same frequency if the selection criteria are fulfilled.
If the cell status “barred” is indicated in MIB but the UE is unable to acquire the SIB1; or
If the cell is to be treated as if the cell status is “barred” due to not supporting RedCap UEs:
   the UE shall exclude the barred cell as a candidate for cell selection/reselection for 300 seconds.
   the UE may select another cell on the same frequency if re-selection criteria are fulfilled.
If the UE is not a RedCap UE, or if the UE is a RedCap UE and intraFreqReselectionRedCap in SIB1 is available:
   If the field intraFreqReselection in MIB message is set to “allowed”:
   the UE may select another cell on the same frequency if re-selection criteria are fulfilled;
   If the cell is to be treated as if the cell status is “barred” due to being unable to acquire the SIB1:
      the UE may exclude the barred cell as a candidate for cell selection/reselection for up to 300 seconds;
   Otherwise:
      the UE shall exclude the barred cell as a candidate for cell selection/reselection for 300 seconds.
If the field intraFreqReselection in MIB message is set to “not allowed”:
   If the cell is to be treated as if the cell status is “barred” due to being unable to acquire the SIB1:
      the UE may exclude the barred cell as a candidate for cell selection/reselection for up to 300 seconds;
      If the cell operates in licensed spectrum:
         the UE shall not re-select to another cell on the same frequency as the barred cell and exclude such cell(s) as candidate(s) for cell selection/reselection for 300 seconds;
      Otherwise:
         the UE may select to another cell on the same frequency if the reselection criteria are fulfilled.
   Otherwise:
      If the cell operates in licensed spectrum, or if this cell belongs to a PLMN which is indicated as being equivalent to the registered PLMN or the selected PLMN of the UE, or if this cell belongs to the registered SNPN or the selected SNPN of the UE:
      the UE shall not re-select to another cell on the same frequency as the barred cell and exclude such cell(s) as candidate(s) for cell selection/reselection for 300 seconds;
   Otherwise:
      the UE may select to another cell on the same frequency if the reselection criteria are fulfilled.
      the UE shall exclude the barred cell as a candidate for cell selection/reselection for 300 seconds.

In some existing wireless networks, SIB1 is periodically transmitted in a cell by a gNB. In these networks, the SIB1 periodicity is 160 ms with repetition at every 20 ms within a 160 ms interval. These periodic transmissions lead to increased network energy consumption. On demand SIB1 can enhance network energy savings wherein a cell can transmit SIB1 upon receiving a request from a UE instead of periodically broadcasting SIB1. In some embodiments, a random access procedure can be used for a SIB1 request. In embodiments such as these, RACH occasions/preambles can be configured for the SIB1 request.

In some embodiments, a UE may request SIB1 as follows:
The UE initiates a random access procedure on a cell. At the initiation of the random access procedure, the UE sets a scaling factor (SCALING_FACTOR_BI) to 1. A preamble transmission counter (PREAMBLE_TRANSMISSION_COUNTER) is set to 1.
The UE selects a random access resource (i.e., a RACH occasion and preamble).
The UE transmits the random access preamble. The UE then monitors a PDCCH addressed to a random access-radio network temporary identifier (RA-RNTI) in a random access response (RAR) window. The UE receives a PDCCH addressed to the RA-RNTI and successfully decodes the transport block (TB) scheduled by the PDCCH. The TB includes a RAR MAC protocol data unit (PDU). If the RAR contains a MAC subPDU with a backoff indicator: the UE sets the PREAMBLE_BACKOFF to a value of the BI field of the MAC subPDU, multiplied with a scaling factor (SCALING_FACTOR_BI).
If the RAR window expires, and if a random access response containing a random access preamble identifier that matches the transmitted PREAMBLE_INDEX has not been received:
   The UE considers the random access response reception not successful and increments PREAMBLE_TRANSMISSION_COUNTER by 1. If PREAMBLE_TRANSMISSION_COUNTER=preambleTransMax+1, the UE considers the random access procedure unsuccessfully completed.
   If the random access procedure is not completed, the UE selects a random backoff time according to a uniform distribution between 0 and the PREAMBLE_BACKOFF, and performs the random access resource selection procedure after the backoff time and transmits the random access preamble again.

An issue with the above approach is that it delays the SIB1 acquisition. This delay prevents the UE from camping, as the UE cannot camp until the SIB1 is acquired. Various embodiments of the present disclosure provide mechanisms to reduce delay related to on demand SIB1 requests.

In some embodiments, a configuration to request SIB1 on a cell (e.g., “Cell B”) can be provided by another cell (e.g., “Cell A”). In embodiments such as, a UE that first camps on Cell A can acquire a configuration to request the SIB1 of Cell B, wherein the request for the SIB1 is sent by the UE to Cell B. The UE can then perform cell reselection to Cell B when reselection criteria as explained above are met. An issue with this procedure is that for cell reselection from Cell A to Cell B, the UE needs certain parameters (e.g., parameters to check whether access to the cell is restricted or not; parameters for final check on cell selection criterion, etc.) which are included in the SIB1 of Cell B for checking whether cell reselection criteria to reselect to Cell B is met. This means that a cell reselection decision will be delayed, as the UE must first send an on demand SIB1 request to Cell B to acquire SIB1 and then perform/validate cell reselection/access criteria and if the cell reselection/access criteria is met perform cell reselection and camp on Cell B.

One approach to avoid such delays is to include a CellAccessRelatedInfo IE from the SIB1 of Cell B in a SIBX transmitted by Cell A, wherein SIBX includes the SIB1 request configuration of Cell B and other cells, similar as shown below:

```
CellAccessRelatedInfo ::= SEQUENCE {
  plmn-IdentityInfoList PLMN-IdentityInfoList,
  cellReservedForOtherUse ENUMERATED {true} OPTIONAL, -- Need R
  ...,
  [[
  cellReservedForFutureUse-r16 ENUMERATED {true} OPTIONAL, -- Need R
  npn-IdentityInfoList-r16 NPN-IdentityInfoList-r16 OPTIONAL -- Need R
  ]],
  [[
  snpn-AccessInfoList-r17 SEQUENCE (SIZE (1..maxNPN-r16)) OF SNPN-AccessInfo-r17
OPTIONAL -- Need R
  ]]
}
SNPN-AccessInfo-r17 ::= SEQUENCE {
  extCH-Supported-r17 ENUMERATED {true} OPTIONAL, -- Need R
  extCH-WithoutConfigAllowed-r17 ENUMERATED {true} OPTIONAL, -- Need R
  onboardingEnabled-r17 ENUMERATED {true} OPTIONAL, -- Need R
  imsEmergencySupportForSNPN-r17 ENUMERATED {true} OPTIONAL -- Need R
}
PLMN-IdentityInfoList ::= SEQUENCE (SIZE (1..maxPLMN)) OF PLMN-IdentityInfo
PLMN-IdentityInfo ::= SEQUENCE {
  plmn-IdentityList SEQUENCE (SIZE (1..maxPLMN)) OF PLMN-Identity,
  trackingAreaCode TrackingAreaCode OPTIONAL, -- Need R
  ranac RAN-AreaCode OPTIONAL, -- Need R
  cellIdentity CellIdentity,
  cellReservedForOperatorUse ENUMERATED {reserved, notReserved},
  ...,
  [[
  iab-Support-r16 ENUMERATED {true} OPTIONAL -- Need S
  ]],
  [[
  trackingAreaList-r17 SEQUENCE (SIZE (1..maxTAC-r17)) OF TrackingAreaCode
OPTIONAL, -- Need R
  gNB-ID-Length-r17 INTEGER (22..32) OPTIONAL -- Cond eventID-TSS
  ]],
  [[
  mobileIAB-Support-r18 ENUMERATED {true} OPTIONAL -- Need S
  ]]
}
```

This approach leads to huge overhead. The CellAccessRelatedInfo IE for each cell include a list of PLMN identities, list of tracking area codes, etc. Each PLMN identity requires 24 bits. Each tracking area code requires 24 bits. There can be up to 12 PLMNs per cell and 12 tracking area codes per cell in a CellAccessRelatedInfo IE. Various embodiments of the present disclosure provide mechanisms for reduced signaling overhead related to on demand SIB1 requests.

As noted above, various embodiments of the present disclosure provide mechanisms to reduce delay related to on demand SIB1 requests.

In some embodiments, if a random access procedure is initiated for a SIB1 request, the UE does not apply backoff (i.e., the UE ignores the backoff received in the RAR during the random access procedure) for random access preamble retransmission during the random access procedure. In embodiments such as these, a random access preamble is transmitted again if the RAR is not successfully received after transmitting the random access preamble.

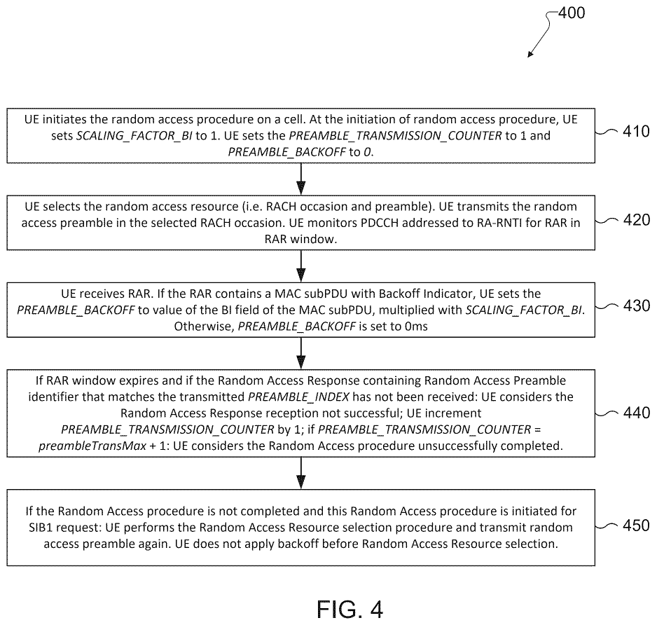

FIG. 4 illustrates an example procedure for backoff handling during a random access procedure 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for backoff handling during a random access procedure could be used without departing from the scope of this disclosure.

In the example of FIG. 4, the procedure 400 begins at operation 410. At operation 410, a UE (such as UE 116 of FIG. 1) initiates a random access procedure on a cell. At the initiation of the random access procedure, the UE sets SCALING_FACTOR_BI to 1, sets the PREAMBLE_TRANSMISSION_COUNTER to 1, and PREAMBLE_BACKOFF is set to 0 ms.

At operation 420, the UE selects a random access resource (i.e., a RACH occasion and preamble). The UE then transmits the random access preamble in the selected RACH occasion, and then monitors for a PDCCH addressed to an RA-RNTI in a RAR window.

At operation 430, the UE receives a PDCCH addressed to the RA-RNTI and successfully decodes the TB scheduled by the PDCCH. The TB includes a RAR MAC PDU. If the RAR contains a MAC subPDU with a backoff indicator, the UE sets the PREAMBLE_BACKOFF to the value of the backoff indicated by the BI field of the MAC subPDU, multiplied with SCALING_FACTOR_BI. Otherwise, PREAMBLE_BACKOFF is set to 0 ms.

At operation 440, if the RAR window expires, and if the random access response containing the random access preamble identifier that matches the transmitted PREAMBLE_INDEX has not been received, the UE considers the random access response reception not successful, increments PREAMBLE_TRANSMISSION_COUNTER by 1, and if PREAMBLE_TRANSMISSION_COUNTER=preambleTransMax+1, the UE considers the random access procedure unsuccessfully completed.

In some embodiments, at operation 450, if the random access procedure is not completed, the UE selects a random backoff time according to a uniform distribution between 0 and the PREAMBLE_BACKOFF. In some embodiments, if this random access procedure is initiated for a SIB1 request (or alternatively for a SIB request, the SIB can be SIB1 or any other SIB), the UE performs the random access resource selection procedure and transmits a random access preamble again, without applying backoff. Otherwise, the UE perform the random access resource selection procedure after the backoff time and transmit random access preamble again.

Alternatively, in some embodiments, at operation 450, if this random access procedure is initiated for a SIB1 request (or alternatively, for a SIB request, the SIB can be SIB1 or any other SIB), the UE performs the random access resource selection procedure and transmit random access preamble again, without applying backoff. Otherwise, if the criteria to select contention-free random access resources is met during the backoff time, the UE performs the random access resource selection procedure and transmits a random access preamble again. Note that dedicated resources for a SIB1 request are not considered as contention-free random-access resources, so, this condition is not applicable for a random-access procedure for a SIB1 request. Otherwise, if the criteria to select contention-free random access resources is not met during the backoff time, the UE performs the random-access resource selection procedure after the backoff time and transmits a random-access preamble again.

Alternatively, in some embodiments, at operation 450, if the random access procedure is not completed and this random access procedure is initiated for a SIB request (for any SIB, including SIB1) and contention free or dedicated RACH resources are configured for the SIB request, the UE performs the random access resource selection procedure and transmits a random access preamble again, without applying backoff.

Although FIG. 4 illustrates one example procedure for backoff handling during a random access procedure 400, various changes may be made to FIG. 4. For example, while shown as a series of operations, various operations in FIG. 4 could overlap, occur in parallel, occur in a different order, occur any number of times, be omitted, or replaced by other operations.

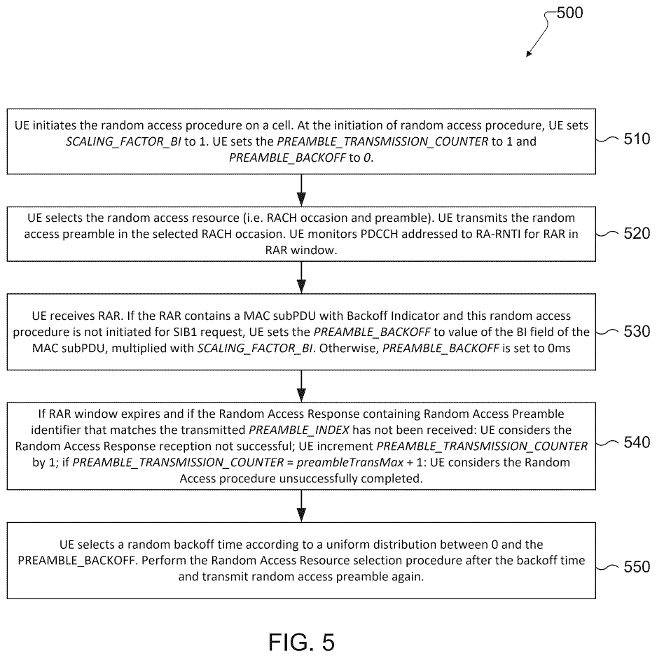

FIG. 5 illustrates another example procedure for backoff handling during a random access procedure 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for backoff handling during a random access procedure could be used without departing from the scope of this disclosure.

In the example of FIG. 5, the procedure 500 begins at operation 510. At operation 510, a UE (such as UE 116 of FIG. 1) initiates a random access procedure on a cell. At the initiation of the random access procedure, the UE sets SCALING_FACTOR_BI to 1, sets the PREAMBLE_TRANSMISSION_COUNTER to 1, and PREAMBLE_BACKOFF is set to 0 ms.

At operation 520, the UE selects a random access resource (i.e., a RACH occasion and preamble). The UE then transmits the random access preamble in the selected RACH occasion, and then monitors for a PDCCH addressed to an RA-RNTI in a RAR window.

In some embodiments, at operation 530, the UE receives a PDCCH addressed to the RA-RNTI and successfully decodes the TB scheduled by the PDCCH. The TB includes RAR MAC PDU. If the RAR contains a MAC subPDU with a backoff indicator and this random access procedure is not initiated for SIB1 request, the UE sets the PREAMBLE_BACKOFF to the value of the backoff indicated by the BI field of the MAC subPDU, multiplied with SCALING_FACTOR_BI. Otherwise (i.e., if the RAR contains a MAC subPDU with a backoff indicator and this random access procedure is initiated for a SIB1 request OR If the RAR does not contain a MAC subPDU with a backoff indicator), PREAMBLE_BACKOFF is set to 0 ms.

Alternatively, in some embodiments, at operation 530, if the RAR contains a MAC subPDU with a backoff indicator: if this random access procedure is initiated for SIB1 request (or alternately for a SIB request configured with contention free or dedicated RACH resources), PREAMBLE_BACKOFF is set to 0 ms; otherwise (i.e., if this random access procedure is not initiated for a SIB1 request [or alternately if this random access procedure is not initiated for SIB request configured with contention free or dedicated RACH resources]), the UE sets the PREAMBLE_BACKOFF to the value of the backoff indicated by the BI field of the MAC subPDU, multiplied with SCALING_FACTOR_BI. Otherwise (i.e. If the RAR does not contain a MAC subPDU with a backoff indicator), PREAMBLE_BACKOFF is set to 0 ms.

Alternatively, in some embodiments, at operation 530, if the RAR contains a MAC subPDU with a backoff indicator and this random access procedure is not initiated for a SIB request (configured with contention free or dedicated RACH resources), the UE sets the PREAMBLE_BACKOFF to value of the backoff indicated by the BI field of the MAC subPDU, multiplied with SCALING_FACTOR_BI. Otherwise, PREAMBLE_BACKOFF is set to 0 ms.

At operation 540, if the RAR window expires, and if the random access response containing the random access preamble identifier that matches the transmitted PREAMBLE_INDEX has not been received, the UE considers the random access response reception not successful, increments PREAMBLE_TRANSMISSION_COUNTER by 1, and if PREAMBLE_TRANSMISSION_COUNTER=preambleTransMax+1, the UE considers the random access procedure unsuccessfully completed.

In some embodiments, at operation 550, if the random access procedure is not completed, the UE selects a random backoff time according to a uniform distribution between 0 and the PREAMBLE_BACKOFF, performs the random access resource selection procedure after the backoff time, and transmits a random access preamble again.

Alternatively, in some embodiments, at operation 550, if the random access procedure is not completed, the UE selects a random backoff time according to a uniform distribution between 0 and the PREAMBLE_BACKOFF. If the criteria to select contention-free random access resources is met during the backoff time the UE performs the random access resource selection procedure and transmits a random access preamble again. Note that dedicated resources for a SIB1 request are not considered contention-free random-access resources, so, this condition is not applicable for a random-access procedure for a SIB1 request. Otherwise, if the criteria to select contention-free random access resources is not met during the backoff time, the UE performs the random access resource selection procedure after the backoff time and transmits a random access preamble again.

Although FIG. 5 illustrates one example procedure for backoff handling during a random access procedure 500, various changes may be made to FIG. 5. For example, while shown as a series of operations, various operations in FIG. 5 could overlap, occur in parallel, occur in a different order, occur any number of times, be omitted, or replaced by other operations.

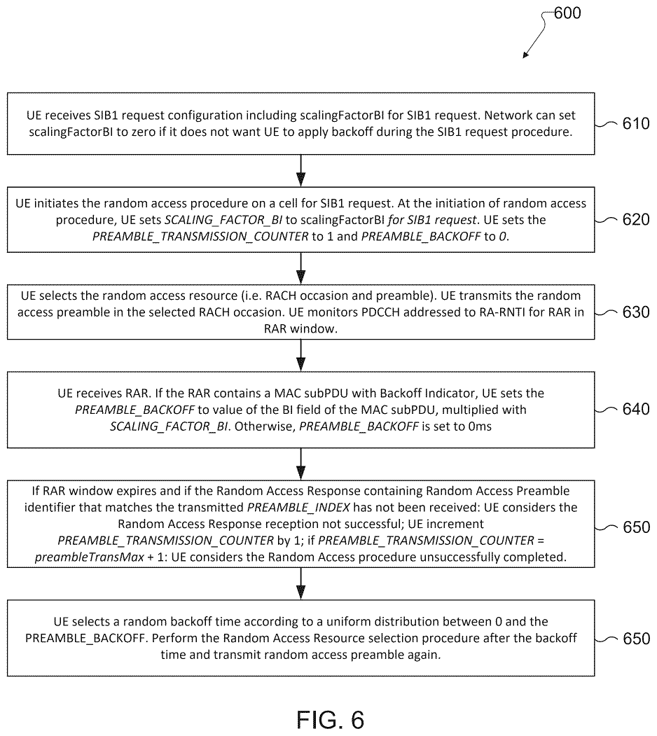

FIG. 6 illustrates another example procedure for backoff handling during a random access procedure 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for backoff handling during a random access procedure could be used without departing from the scope of this disclosure.

In the example of FIG. 6, the procedure 600 begins at operation 610. At operation 610, a UE (such as UE 116 of FIG. 1) receives a SIB1 request configuration including a backoff indicator value scalingFactorBI for a SIB1 request to a cell. If the Network does not want the UE to apply backoff during the SIB1 request procedure, scalingFactorBI is set to zero.

At operation 620, the UE initiates a random access procedure on the cell for a SIB1 request. At the initiation of the random access procedure, the UE sets SCALING_FACTOR_BI to scalingFactorBI for the SIB1 request, sets the PREAMBLE_TRANSMISSION_COUNTER to 1, and PREAMBLE_BACKOFF is set to 0 ms.

At operation 630, the UE selects a random access resource (i.e., a RACH occasion and preamble). The UE then transmits the random access preamble in the selected RACH occasion, and then monitors for a PDCCH addressed to an RA-RNTI in a RAR window.

At operation 640, the UE receives a PDCCH addressed to the RA-RNTI and successfully decodes the TB scheduled by the PDCCH. The TB includes a RAR MAC PDU. If the RAR contains a MAC subPDU with a backoff indicator, the UE sets the PREAMBLE_BACKOFF to the value of the backoff indicated by the BI field of the MAC subPDU, multiplied with SCALING_FACTOR_BI. Otherwise, PREAMBLE_BACKOFF is set to 0 ms.

At operation 650, if the RAR window expires, and if the random access response containing the random access preamble identifier that matches the transmitted PREAMBLE_INDEX has not been received, the UE considers the random access response reception not successful, increments PREAMBLE_TRANSMISSION_COUNTER by 1, and if PREAMBLE_TRANSMISSION_COUNTER=preambleTransMax+1, the UE considers the random access procedure unsuccessfully completed.

If the random access procedure is not completed, at operation 660 the UE selects a random backoff time according to a uniform distribution between 0 and the PREAMBLE_BACKOFF, performs the random access resource selection procedure after the backoff time, and transmits a random access preamble again.

In some embodiments, the procedure of FIG. 6 can also be applied for any SIB request (such as for SIB1 or any other SIB).

Although FIG. 6 illustrates one example procedure for backoff handling during a random access procedure 600, various changes may be made to FIG. 6. For example, while shown as a series of operations, various operations in FIG. 6 could overlap, occur in parallel, occur in a different order, occur any number of times, be omitted, or replaced by other operations.

In some embodiments, a UE can be camped on a cell (e.g., “Cell A”). If the UE is in an RRC_IDLE or in RRC_INACTIVE state, and if SIB1 acquisition is required from the cell and the UE has a stored valid version of ul-WUS-Config (or a SIB1 request configuration) for the cell, the UE can acquire the MIB of the cell. If the UE fails to acquire the MIB, the can UE bar the cell. If the MIB is acquired and SIB1 is provided on demand based on the acquired MIB (i.e., ssb-SubcarrierOffset indicates that SIB1 is not scheduled in the cell or provided on demand in the cell), the UE can transmit a SIB1 request to the cell using the SIB1 request configuration of the cell.

Alternatively, in some embodiments, if SIB1 acquisition is required from the cell and the UE has a stored valid version of ul-WUS-Config (or a SIB1 request configuration) for the cell, the UE can acquire the MIB of the cell. If the UE fails to acquire the MIB, the UE can bar the cell. If the MIB is acquired and SIB1 is provided on demand based on the acquired MIB (i.e., ssb-SubcarrierOffset indicates that SIB1 is not scheduled in the cell or provided on demand in the cell), the UE can transmit a SIB1 request to the cell using the SIB1 request configuration of the cell.

In some embodiments, a UE can be camped on a cell (e.g., “Cell A”). If the UE is in an RRC_IDLE or in RRC_INACTIVE state and if SIB1 acquisition is required for the cell and the UE supports a SIB1 request procedure (or on demand SIB1), the UE can acquire the MIB of the cell. If the UE fails to acquire the MIB, the UE can bar the cell. If the MIB is acquired and SIB1 is p rovided on demand based on the acquired MIB (i.e., ssb-SubcarrierOffset indicates that SIB1 is not scheduled in the cell or provided on demand in the cell), the UE can transmit a SIB1 request to the cell using the SIB1 request configuration of the cell.

Alternatively, in some embodiments, if SIB1 acquisition is required for the cell and UE supports a SIB1 request procedure (or on demand SIB1), the UE can acquire the MIB of the cell. If the UE fails to acquire the MIB, UE can bar the cell. If the MIB is acquired and SIB1 is provided on demand based on the acquired MIB (i.e., ssb-SubcarrierOffset indicates that SIB1 is not scheduled in the cell or provided on demand in the cell), the UE can transmit a SIB1 request to the cell using the SIB1 request configuration of the cell.

In some embodiments, a UE can be camped on a cell (e.g., “Cell A”). If the UE is in an RRC_IDLE or in RRC_INACTIVE state, and if SIB1 acquisition is required from the cell and the cell supports SIB1 requests (e.g., the cell supports SIBX or the UE has SIBX acquired from cell which includes a SIB1 request configuration of the cell), the UE can acquire the MIB of the cell. If the UE fails to acquire the MIB, the UE can bar the cell. If the MIB is acquired and SIB1 is provided on demand based on the acquired MIB (i.e., ssb-SubcarrierOffset indicates that SIB1 is not scheduled in the cell or provided on demand in the cell), the UE can transmit a SIB1 request to the cell using the SIB1 request configuration of the cell.

Alternatively, in some embodiments, if SIB1 acquisition is required from the cell and the cell supports SIB1 requests (e.g., the cell supports SIBX or the UE has SIBX acquired from the cell which includes a SIB1 request configuration of the cell), the UE can acquire the MIB of the cell. If the UE fails to acquire the MIB, the UE can bar the cell. If the MIB is acquired and SIB1 is p rovided on demand based on the acquired MIB (i.e., ssb-SubcarrierOffset indicates that SIB1 is not scheduled in the cell or provided on demand in the cell), the UE can transmit a SIB1 request to the cell using the SIB1 request configuration of the cell.

As noted above, various embodiments of the present disclosure provide mechanisms for reduced signaling overhead related to on demand SIB1 requests.

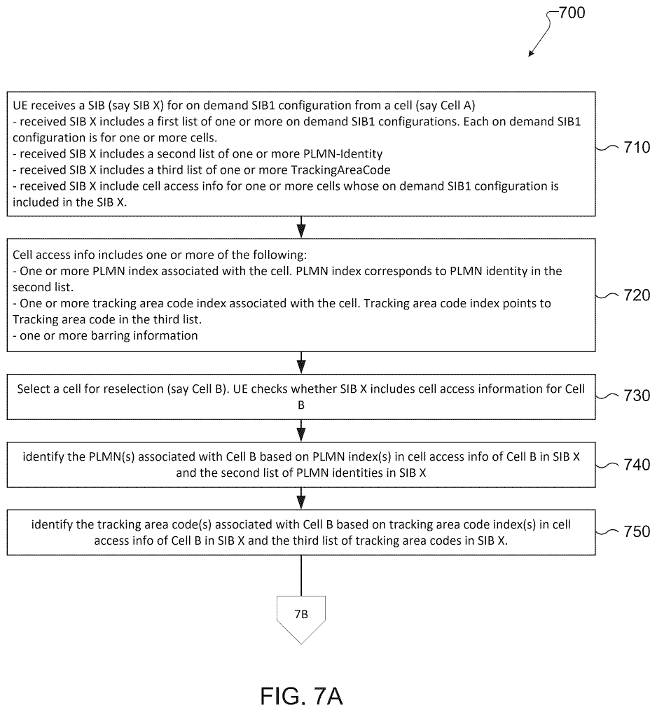

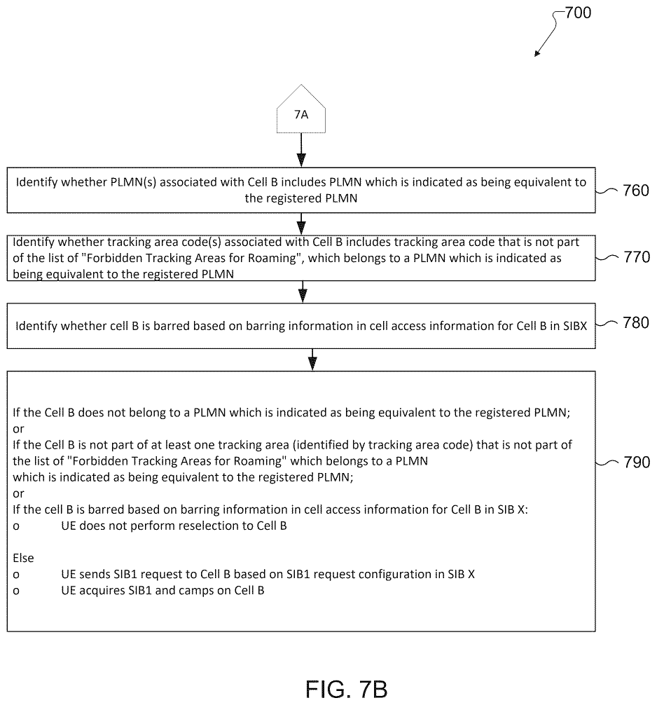

FIGS. 7A-7B illustrate an example procedure for on demand SIB request 700 according to embodiments of the present disclosure. An embodiment of the procedure illustrated in FIGS. 7A-7B is for illustration only. One or more of the components illustrated in FIGS. 7A-7B may be implemented in specialized circuitry configured to perform the noted functions or one or more of the components may be implemented by one or more processors executing instructions to perform the noted functions. Other embodiments of a procedure for an on demand SIB request could be used without departing from the scope of this disclosure.

In the example of FIGS. 7A-7B, the procedure 700 begins at operation 710. At operation 710, a UE (such as UE 116 of FIG. 1) receives a SIB (e.g., “SIB X”) for an on demand SIB1 configuration from a cell (e.g., “Cell A”).

The received SIB X includes a first list of one or more on demand SIB1 configurations. Each on demand SIB1 configuration is for one or more cells. Each On demand SIB1 configuration includes an absolute radio frequency channel number (ARFCN) and list of physical cell identities (PCIs) associated with that demand SIB1 configuration.

The received SIB X also includes a second list of one or more PLMN-Identities. In some embodiments, each PLMN-Identity is defined as shown below:

PLMN-Identity information element

```
PLMN-Identity ::= SEQUENCE {
  mcc MCC OPTIONAL, -- Cond MCC
  mnc MNC
}
MCC ::= SEQUENCE (SIZE (3)) OF MCC-MNC-Digit
MNC ::= SEQUENCE (SIZE (2..3)) OF MCC-MNC-Digit
MCC-MNC-Digit ::= INTEGER (0..9)
```

The received SIB X further includes a third list of one or more TrackingAreaCodes. In some embodiments, each TrackingAreaCode is defined as shown below:

### TrackingAreaCode Information Element

TrackingAreaCode::=BIT STRING (SIZE (24))

The received SIB X also includes cell access information for one or more cells whose on demand SIB1 configuration is included in the SIB X. In some embodiments, the cell access information can be included per on demand SIB1 configuration. In some embodiments, a list of cell access information can be included in SIB X.

At operation 720, the cell access information includes one or more of the following:
One or more PLMN indexes associated with the cell. Each PLMN index points to a PLMN identity in the second list. For example, PLMN index 1 corresponds to a PLMN identity in the first entry in the second list, PLMN index 2 corresponds to a PLMN identity in the second entry in the second list, index n corresponds to a PLMN identity in the nth entry in the second list, etc. Based on the PLMN index(s) and the second list, the UE can identify PLMN(s) associated with the cell.
One or more tracking area code indexes associated with the cell. Each tracking area code index points to tracking area code in the third list. For example, tracking area code index 1corresponds to a tracking area code in the first entry in the third list, tracking area code index 2 corresponds to a tracking area code in the second entry in the third, tracking area code index n corresponds to a tracking area code in the nth entry in the third list, etc. Based on the tracking area code index(s) and the third list, the UE can identify tracking area code(s) associated with the cell.
cellReservedForOtherUse
cellReservedForFutureUse
cellBarredATG
cellBarredNES
cellBarred-eRedCap1Rx
cellBarred-eRedCap2Rx
cellBarredRedCap1Rx
cellBarredRedCap2Rx
cellBarredNTN
cellBarred
IFRI bit
ARFCN/PCI or index to list of cell info where cell info includes ARFCN/PCI.

At operation 730, the UE selects a cell for reselection (e.g., “Cell B”), and checks whether the SIB X includes cell access information for Cell B.

If SIB X includes cell access information for Cell B:
At operation 740 the UE identifies the PLMN(s) associated with Cell B based on the PLMN index(s) in the cell access info of Cell B in SIB X and the second list of PLMN identities in SIB X.
At operation 750, the UE identifies the tracking area code(s) associated with Cell B based on the tracking area code index(s) in the cell access information of Cell B in SIB X and the third list of tracking area codes in SIB X. Note that Cell B can be associated with different tracking area code(s) for different PLMN(s).
At operation 760, the UE identifies whether Cell B belongs to a PLMN which is indicated as being equivalent to the registered PLMN (i.e., whether the PLMN(s) associated with Cell B includes the PLMN which is indicated as being equivalent to the registered PLMN).
At operation 770, the UE identifies whether Cell B is part of at least one tracking area (identified by a tracking area code) that is not part of the list of “Forbidden Tracking Areas for Roaming” which belongs to a PLMN which is indicated as being equivalent to the registered PLMN (i.e., whether the tracking area code(s) associated with Cell B includes a tracking area code that is not part of the list of “Forbidden Tracking Areas for Roaming”, which belongs to a PLMN which is indicated as being equivalent to the registered PLMN 0.
At operation 780, the UE Identifies whether cell B is barred based on barring information in the cell access information for Cell B in SIB X.
At operation 790, if Cell B does not belong to a PLMN which is indicated as being equivalent to the registered PLMN, or if Cell B is not part of at least one tracking area (identified by a tracking area code) that is not part of the list of “Forbidden Tracking Areas for Roaming” which belongs to a PLMN which is indicated as being equivalent to the registered PLMN, or if the cell B is barred based on barring information in the cell access information for Cell B in SIB X, the UE does not perform reselection to Cell B. Otherwise:
   The UE sends a SIB1 request to Cell B based on the SIB1 request configuration in SIB X.
   The UE acquires SIB1 and camps on Cell B.

In some embodiments, signaling for cell access information in SIB X may follow one of Option 1 or Option 2 as shown below:

### Option 1

```
Common info in SIB X:
od-SIB1-CellConfigList-r19 SEQUENCE (SIZE(1..maxCellODSIB1-r19)) OF OD-SIB1-
CellConfig-r19 plmn-IdentityListCommon SEQUENCE (SIZE (1..maxPLMN)) OF PLMN-
Identity
trackingAreaListCommon SEQUENCE (SIZE (1..maxTAC)) OF TrackingAreaCode
dedicated info per OD-SIB1 configuration in SIBX
CellAccessRelatedInfoOD-SIB1 ::= SEQUENCE {
  plmn-IdentityInfoList PLMN-Identity InfoListOD-SIB1,
  cellReservedForOtherUse ENUMERATED {true} OPTIONAL, -- Need R
  cellReservedForFutureUse ENUMERATED {true} OPTIONAL, -- Need R
  cellBarredATG ENUMERATED {barred, notBarred} OPTIONAL, -- Need S
  cellBarredNES ENUMERATED {notBarred} OPTIONAL, -- Need R
  cellBarred-eRedCap1Rx ENUMERATED {barred, notBarred}, OPTIONAL,
  cellBarred-eRedCap2Rx ENUMERATED {barred, notBarred}, OPTIONAL,
  cellBarredRedCap1Rx ENUMERATED {barred, notBarred}, OPTIONAL,
  cellBarredRedCap2Rx ENUMERATED {barred, notBarred}, OPTIONAL,
    cellBarredNTN ENUMERATED {barred, notBarred} OPTIONAL,
}
PLMN-IdentityInfoListOD-SIB1 ::= SEQUENCE (SIZE (1..maxPLMN)) OF PLMN-
IdentityInfoOD-SIB1
PLMN-IdentityInfoOD-SIB1 ::= SEQUENCE {
  plmn-IdentityList INTEGER (1.. maxPLMN), (Note: index is used instead of full
identity)
  trackingAreaCode INTEGER (1.. maxTAC), (Note: index is used instead of full
identity) OPTIONAL, -- Need R
  cellReservedForOperatorUse ENUMERATED {reserved, notReserved},
  trackingAreaList SEQUENCE (SIZE (1..maxTAC)) OF INTEGER (1.. maxTAC)
(Note: index is used instead of full identity)
OPTIONAL, -- Need R
}
```

### Option 2

```
Common info in SIBxx:
od-SIB1-CellConfigList-r19 SEQUENCE (SIZE(1..maxCellODSIB1-r19)) OF OD-SIB1-
CellConfig-r19 plmn-IdentityListCommon SEQUENCE (SIZE (1..maxPLMN)) OF PLMN-
Identity
trackingAreaListCommon SEQUENCE (SIZE (1..maxTAC)) OF TrackingAreaCode
cellListCommon SEQUENCE (SIZE (1..maxcell)) OF Cell Info (cell info include
ARFCN/PCI)
plmn-IdentityInfoList PLMN-IdentityInfoListOD-SIB1
PLMN-IdentityInfoListOD-SIB1::= SEQUENCE (SIZE (1..maxPLMN)) OF PLMN-
IdentityInfoOD-SIB1
PLMN-IdentityInfoOD-SIB1 ::= SEQUENCE {
  plmn-IdentityList INTEGER (1.. maxPLMN), (Note: index is used instead of full
identity)
  trackingAreaCode INTEGER (1.. maxTAC), (Note: index is used instead of full
identity) OPTIONAL, -- Need R
  cellReservedForOperatorUse ENUMERATED {reserved, notReserved},
  trackingAreaList SEQUENCE (SIZE (1..maxTAC)) OF INTEGER (1.. maxTAC)
(Note: index is used instead of full identity) OPTIONAL, -- Need R
  index(es) to cellListCommon
}
cellBarringRelatedInfoListOD-SIB1 SEQUENCE (SIZE (1..maxCell)) OF
CellBarringRelatedInfoOD-SIB1
CellBarringRelatedInfoOD-SIB1 ::= SEQUENCE {
  cellReservedForOtherUse ENUMERATED {true} OPTIONAL, -- Need R
  cellReservedForFutureUse ENUMERATED {true} OPTIONAL, -- Need R
  cellBarredATG ENUMERATED {barred, notBarred} OPTIONAL, -- Need S
  cellBarredNES ENUMERATED {notBarred} OPTIONAL, -- Need R
  cellBarred-eRedCap1Rx ENUMERATED {barred, notBarred}, OPTIONAL,
  cellBarred-eRedCap2Rx ENUMERATED {barred, notBarred}, OPTIONAL,
  cellBarredRedCap1Rx ENUMERATED {barred, notBarred}, OPTIONAL,
  cellBarredRedCap2Rx ENUMERATED {barred, notBarred}, OPTIONAL,
    cellBarredNTN ENUMERATED {barred, notBarred} OPTIONAL,
  index(es) to cellListCommon
}
SIBxx-r19 ::= SEQUENCE {
od-SIB1-CellConfigList-r19 SEQUENCE (SIZE(1..maxCellODSIB1-r19)) OF OD-SIB1-
CellConfig-r19 OPTIONAL, -- Need R
plmn-IdentityListCommon SEQUENCE (SIZE (1..maxPLMN)) OF PLMN-Identity
OPTIONAL, -- Need R
trackingAreaListCommon SEQUENCE (SIZE (1..maxTAC)) OF TrackingAreaCode
OPTIONAL, -- Need R
<add cell access info here>
lateNonCriticalExtension OCTET STRING OPTIONAL,
  ...
}
```

Although FIGS. 7A-7B illustrate one example procedure for an on demand SIB request 700, various changes may be made to FIGS. 7A-7B. For example, while shown as a series of operations, various operations in FIGS. 7A-7B could overlap, occur in parallel, occur in a different order, occur any number of times, be omitted, or replaced by other operations.

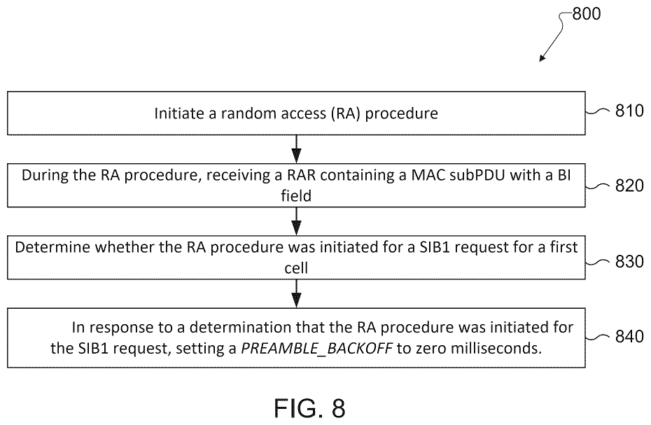

FIG. 8 illustrates an example method for backoff handling for a SIB1 request 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for backoff handling for a SIB1 request could be used without departing from the scope of this disclosure.

In the example of FIG. 8, the method 800 begins at step 810. At step 810, a UE (such as UE 116 of FIG. 1) initiates an RA procedure. During the RA procedure, at step 820, the UE receives a RAR containing a MAC subPDU with a BI field.

At step 830, the UE determines whether the RA procedure was initiated for a SIB1 request for a first cell. In response to a determination that the RA procedure was initiated for the SIB 1 request, at step 840 the UE sets a PREAMBLE_BACKOFF to zero milliseconds.

In some embodiments, in response to a determination that the RA procedure was not initiated for the SIB1 request, the UE may set the PREAMBLE_BACKOFF based on a value associated with the BI field. In some embodiments, to set the PREAMBLE_BACKOFF based on a value associated with the BI field, the UE may set the PREAMBLE_BACKOFF to a value of the BI field multiplied by a SCALING_FACTOR_BI. In some embodiments, at the initiation of the RA procedure, the UE may set the SCALING_FACTOR_BI to 1.

In some embodiments, the UE may receive a SIB a second cell that includes an on demand SIB1 configuration of the first cell. In embodiments such as these, the RA procedure may be initiated by the UE based on the on demand SIB1 configuration of the first cell. The SIB may include (i) a first list comprising on demand SIB1 configurations, the first list including the on demand SIB1 configurations, (ii) a second list comprising PLMN identities, and (iii) a third list comprising tracking area codes. Each on demand SIB1 configuration comprised by the first list may include cell access information. In some embodiments, the PLMN identities in the second list may be sequentially indexed, the tracking area codes in the third list may be sequentially indexed, and the cell access information may include (i) at least one PLMN index pointing to a PLMN identity in the second list, (ii) at least one tracking area code index pointing to a tracking area code in the second list, and (iii) cell barring information. In embodiments such as these, the UE may identify at least one PLMN associated with the first cell based on (i) at least one PLMN index in the cell access information corresponding with the on demand SIB1 configuration of the first cell and (ii) the second list, and identify at least one tracking area code associated with the first cell based on (i) at least one tracking area code index in the cell access information corresponding with the on demand SIB1 configuration of the first cell and (ii) the third list. The UE may also determine whether the at least one PLMN associated with the first cell includes a registered PLMN of the UE, determine whether the at least one tracking area code associated with the first cell includes a tracking area code that is not forbidden, and determine whether the first cell is barred based on cell barring information in the cell access information corresponding with the on demand SIB1 configuration of the first cell. The RA procedure may be initiated by the UE in response to a determination that the at least one PLMN associated with the first cell includes a registered PLMN of the UE, a determination that the at least one tracking area code associated with the first cell includes a tracking area code that is not forbidden, and a determination that the first cell is not barred.

Although FIG. 8 illustrates one example method for backoff handling for a SIB1 request 800, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a user equipment (UE), the method comprising:
initiating a random access (RA) procedure;
during the RA procedure, receiving a random access response (RAR) containing a medium access control (MAC) sub protocol data unit (subPDU) with a backoff indicator (BI) field;
determining whether the RA procedure was initiated for a system information block 1 (SIB1) request for a first cell; and
in response to a determination that the RA procedure was initiated for the SIB1 request, setting a preamble backoff (PREAMBLE_BACKOFF) to zero milliseconds.

2. The method of claim 1, further comprising, in response to a determination that the RA procedure was not initiated for the SIB1 request, setting the PREAMBLE_BACKOFF based on a value associated with the BI field.

3. The method of claim 2, wherein setting the PREAMBLE_BACKOFF based on a value associated with the BI field comprises setting the PREAMBLE_BACKOFF to a value of the BI field multiplied by a scaling factor (SCALING_FACTOR_BI).

4. The method of claim 3, further comprising, at the initiation of the RA procedure, setting the SCALING_FACTOR_BI to 1.

5. The method of claim 1, further comprising receiving a system information block (SIB) from a second cell, the SIB including an on demand SIB1 configuration of the first cell,
wherein the RA procedure is initiated by the UE based on the on demand SIB1 configuration of the first cell.

6. The method of claim 5, wherein the SIB includes:
a first list comprising on demand SIB1 configurations, the first list including the on demand SIB1 configurations;
a second list comprising public land mobile network (PLMN) identities; and
a third list comprising tracking area codes.

7. The method of claim 6, wherein each on demand SIB1 configuration comprised by the first list includes cell access information.

8. The method of claim 7, wherein:
the PLMN identities in the second list are sequentially indexed;
the tracking area codes in the third list are sequentially indexed; and
the cell access information includes:
at least one PLMN index pointing to a PLMN identity in the second list;
at least one tracking area code index pointing to a tracking area code in the second list; and
cell barring information.

9. The method of claim 8, further comprising:
identifying at least one PLMN associated with the first cell based on (i) at least one PLMN index in the cell access information corresponding with the on demand SIB1 configuration of the first cell and (ii) the second list;
identifying at least one tracking area code associated with the first cell based on (i) at least one tracking area code index in the cell access information corresponding with the on demand SIB1 configuration of the first cell and (ii) the third list;
determining whether the at least one PLMN associated with the first cell includes a registered PLMN of the UE;
determining whether the at least one tracking area code associated with the first cell includes a tracking area code that is not forbidden; and
determining whether the first cell is barred based on cell barring information in the cell access information corresponding with the on demand SIB1 configuration of the first cell.

10. The method of claim 9, wherein the RA procedure is initiated by the UE in response to:
a determination that the at least one PLMN associated with the first cell includes a registered PLMN of the UE;
a determination that the at least one tracking area code associated with the first cell includes a tracking area code that is not forbidden; and
a determination that the first cell is not barred.

11. An electronic device comprising:
at least on processor including processing circuitry; and
memory storing instructions, wherein the instructions, when executed by the at least one processor individually or collectively, cause the electronic device to:
initiate a random access (RA) procedure;
during the RA procedure, receive a random access response (RAR) containing a medium access control (MAC) sub protocol data unit (subPDU) with a backoff indicator (BI) field;
determine whether the RA procedure was initiated for a system information block 1 (SIB1) request for a first cell; and
in response to a determination that the RA procedure was initiated for the SIB1 request, set a preamble backoff (PREAMBLE_BACKOFF) to zero milliseconds.

12. The electronic device of claim 11, wherein the instructions, when executed by the at least one processor individually or collectively, further cause the electronic device to, in response to a determination that the RA procedure was not initiated for the SIB1 request, set the PREAMBLE_BACKOFF based on a value associated with the BI field.

13. The electronic device of claim 12, wherein setting the PREAMBLE_BACKOFF based on a value associated with the BI field comprises setting the PREAMBLE_BACKOFF to a value of the BI field multiplied by a scaling factor (SCALING_FACTOR_BI).

14. The electronic device of claim 13, wherein the instructions, when executed by the at least one processor individually or collectively, further cause the electronic device to, at the initiation of the RA procedure, set the SCALING_FACTOR_BI to 1.

15. The electronic device of claim 11, wherein the instructions, when executed by the at least one processor individually or collectively, further cause the electronic device to receive a system information block (SIB) from a second cell, the SIB including an on demand SIB1 configuration of the first cell,
wherein the RA procedure is initiated by the electronic device based on the on demand SIB1 configuration of the first cell.

16. The electronic device of claim 15, wherein the SIB includes:
a first list comprising on demand SIB1 configurations, the first list including the on demand SIB1 configurations;
a second list comprising public land mobile network (PLMN) identities; and
a third list comprising tracking area codes.

17. The electronic device of claim 16, wherein each on demand SIB1 configuration comprised by the first list includes cell access information.

18. The electronic device of claim 17, wherein:
the PLMN identities in the second list are sequentially indexed;
the tracking area codes in the third list are sequentially indexed; and
the cell access information includes:
at least one PLMN index pointing to a PLMN identity in the second list;
at least one tracking area code index pointing to a tracking area code in the second list; and
cell barring information.

19. The electronic device of claim 18, wherein the instructions, when executed by the at least one processor individually or collectively, further cause the electronic device to:
identify at least one PLMN associated with the first cell based on (i) at least one PLMN index in the cell access information corresponding with the on demand SIB1 configuration of the first cell and (ii) the second list;
identify at least one tracking area code associated with the first cell based on (i) at least one tracking area code index in the cell access information corresponding with the on demand SIB1 configuration of the first cell and (ii) the third list;
determine whether the at least one PLMN associated with the first cell includes a registered PLMN of the UE;
determine whether the at least one tracking area code associated with the first cell includes a tracking area code that is not forbidden; and
determine whether the first cell is barred based on cell barring information in the cell access information corresponding with the on demand SIB1 configuration of the first cell.

20. The electronic device of claim 19, wherein the RA procedure is initiated by the electronic device in response to:
a determination that the at least one PLMN associated with the first cell includes a registered PLMN of the UE;
a determination that the at least one tracking area code associated with the first cell includes a tracking area code that is not forbidden; and
a determination that the first cell is not barred.
